(19) United States
(12) Patent Application Publication
(10) Pub. No.: US 2003/0081778 A1
(43) Pub. Date: May 1, 2003

(54) Image recording apparatus, image reproduction apparatus, and information recording medium

(76) Inventors: Yasufumi Tsumagari, Yokohama-shi (JP); Hideki Mimura, Yokohama-shi (JP); Taku Kato, Kamakura-shi (JP)

Correspondence Address: PILLSBURY WINTHROP, LLP, P.O. BOX 10500, MCLEAN, VA, 22102, US

(21) Appl. No.: 10/284,493

(22) Filed: Oct. 31, 2002

(30) Foreign Application Priority Data
Oct. 31, 2001 (JP) 2001-335419

(51) Int. Cl. H04N 7/167

(52) U.S. Cl. 380/201

(57) ABSTRACT

There is disclosed a method comprising inputting predetermined information including a plurality of data packet, using a plurality of pieces of key information which differs with each data packet to encrypt the inputted predetermined information, and recording the encrypted predetermined information into a recording area of an information recording medium. There is also disclosed a method comprising reading the predetermined information stored in the recording area of the information recording medium, and using the plurality of pieces of key information which differs with each data packet to decrypt the read predetermined information.

### CROSS-REFERENCE TO RELATED APPLICATIONS

This application is based upon and claims the benefit of priority from the prior Japanese Patent Application No. 2001-335419, filed Oct. 31, 2001, the entire contents of which are incorporated herein by reference.

### BACKGROUND OF THE INVENTION

1. Field of the Invention

The present invention relates to an information recording apparatus, information reproduction apparatus, and information recording medium in which data packet is handled, particularly to an improvement of encryption/decryption of data packet.

2. Description of the Related Art

As well known, in recent years, with the progress in digital information recording/reproduction apparatuses, there are growing demands for countermeasures against illegal copying by a third party, in terms of copyright protection.

For example, to apply encryption with respect to DVD video recording standard, a recording apparatus, recording medium, and a key formed of a part (8 bytes) of data to be recorded are used to encrypt data by a pack unit in conformity with an MPEG program stream.

That is, in the DVD video recording standard, the key is generated based on information obtained from the recording apparatus and recording medium. The key is recorded in the recording medium. The recording apparatus generates the pack of 2048 bytes in conformity with the MPEG program stream, and combines 8 bytes, copy control information, and the above-described key to generate a new key. Based on the key, the data of 1920 bytes out of 2048 bytes is encrypted.

However, when the above-described method is applied to the DVD stream recording standard, and the pack conforming to the MPEG program stream is encrypted, time information required for access is also encrypted. Therefore, the problem is that it is difficult to access the information.

Moreover, there is problem that there is plenty of scope for enhancement of difficulty of decoding against an illegal decoding by the third party.

### BRIEF SUMMARY OF THE INVENTION

The present invention has been developed in consideration of the above-described circumstances, and an object thereof is to provide an information recording apparatus, information reproduction apparatus, and information recording medium in which encryption is performed with key information different for each packet, thereby a high decoding difficulty is achieved and an access speed is enhanced.

According to one aspect of the present invention, there is provided an information recording apparatus comprising:

an input section configured to input predetermined information as a plurality of data packet supplied as a unit of data packet;

an encryption section configured to use a plurality of pieces of key information which differ with each data packet to encrypt the predetermined information inputted by the input section; and

a recording section configured to record the encrypted predetermined information encrypted by the encryption section into a recording area of an information recording medium.

According to one aspect of the present invention, there is provided an information reproduction apparatus comprising:

a readout section configured to read out predetermined information which is stored in a recording area of an information recording medium and encrypted by a unit of data packet; and

a reproduction section configured to use a plurality of pieces of key information which differ with the data packet unit to decrypt and reproduce the predetermined information read out by the readout section.

According to one aspect of the present invention, there is provided an information recording medium which stores predetermined information encrypted for each data packet and in which a plurality of encrypted data packet encrypted by a plurality of pieces of key information different with each packet are stored in a recording area.

### BRIEF DESCRIPTION OF THE SEVERAL VIEWS OF THE DRAWING

FIG. 1 is a system diagram showing one example of a system for recording/reproduction data packet;

FIG. 2 is a diagram showing a data structure in recording packets by an encryption/decryption method of an information recording/reproduction apparatus in a DVD-SR standard;

FIG. 3 is an explanatory view showing one example of a recording function of the information recording/reproduction apparatus;

FIG. 4 is an explanatory view showing one example of a reproduction function of the information recording/reproduction apparatus;

FIG. 5 is a flowchart showing one example of the recording function of the information recording/reproduction apparatus;

FIG. 6 is a flowchart showing one example of the reproduction function of the information recording/reproduction apparatus;

FIG. 7 is an explanatory view showing one example of the recording function of the information recording/reproduction apparatus;

FIG. 8 is an explanatory view showing one example of the reproduction function of the information recording/reproduction apparatus;

FIG. 9 is an explanatory view showing an encryption process of the information recording/reproduction apparatus according to a first embodiment of the present invention;

FIG. 10 is an explanatory view showing a decryption process of the information recording/reproduction apparatus according to the first embodiment of the present invention;

FIG. 11 is an explanatory view showing the encryption process of the information recording/reproduction apparatus according to a second embodiment of the present invention;

FIG. 12 is an explanatory view showing the decryption process of the information recording/reproduction apparatus according to the second embodiment of the present invention;

FIG. 13 is a diagram showing one example of a structure of management information of an information recording medium;

FIG. 14 is a diagram showing one example of a structure of object information of the information recording medium;

FIG. 15 is an explanatory view showing the encryption process of the information recording/reproduction apparatus according to a third embodiment of the present invention;

FIG. 16 is an explanatory view showing the decryption process of the information recording/reproduction apparatus according to the third embodiment of the present invention; and

FIG. 17 is a block diagram showing one example of an optical disk information recording/reproduction apparatus.

### DETAILED DESCRIPTION OF THE INVENTION

Embodiments of the present invention will be described hereinafter with reference to the drawings.

First Embodiment

According to a first embodiment, there are provided an information recording/reproduction apparatus, information recording medium and information recording/reproduction method in which key information different with each data packet is used to encrypt the data packet. Particularly, a case will be described in which the key information is generated based on reach information and a part of the data packet.

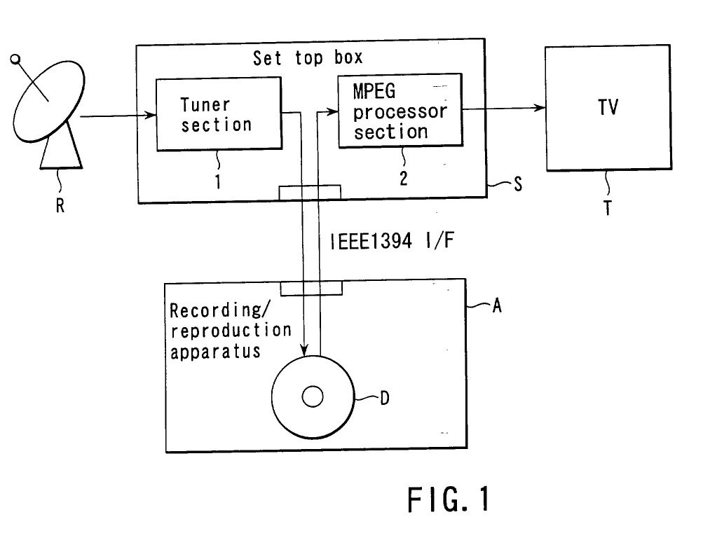

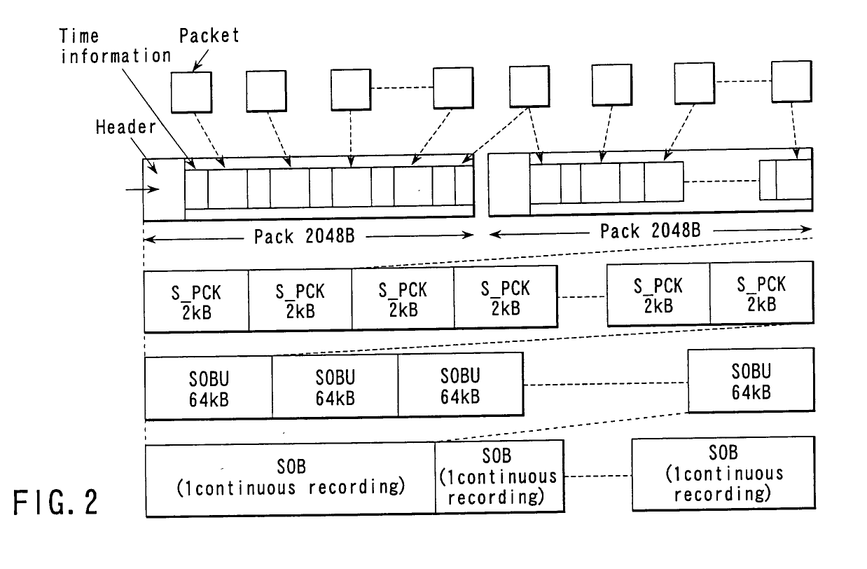

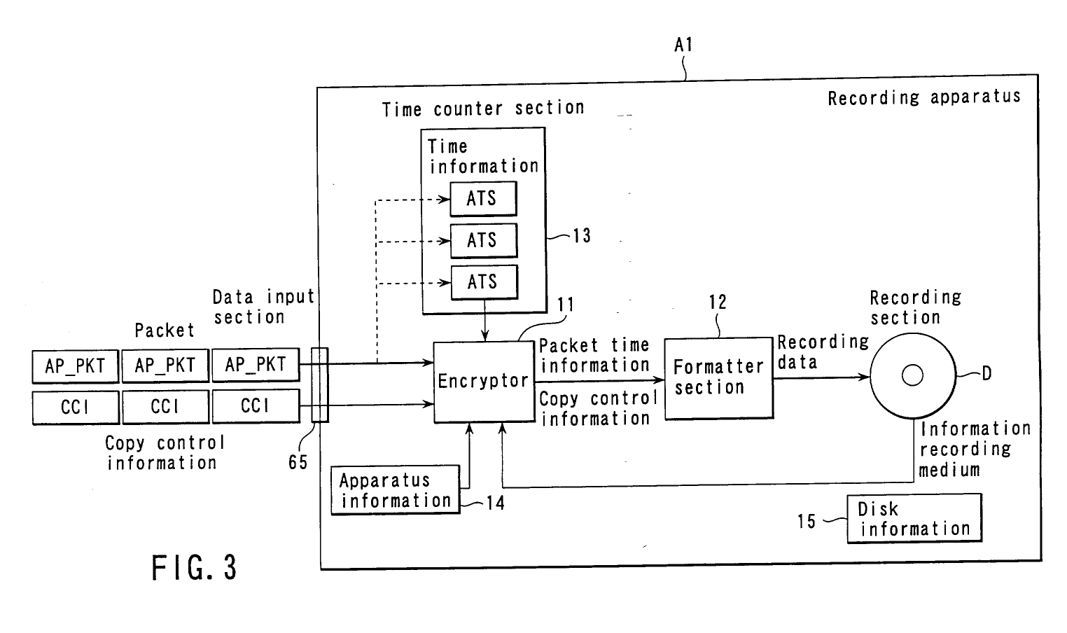

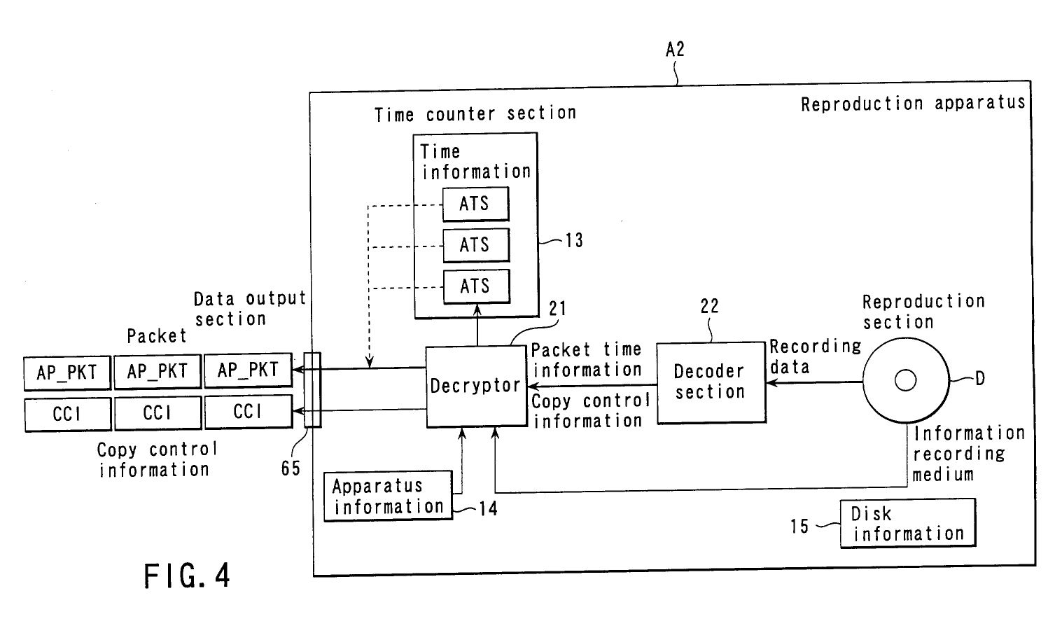

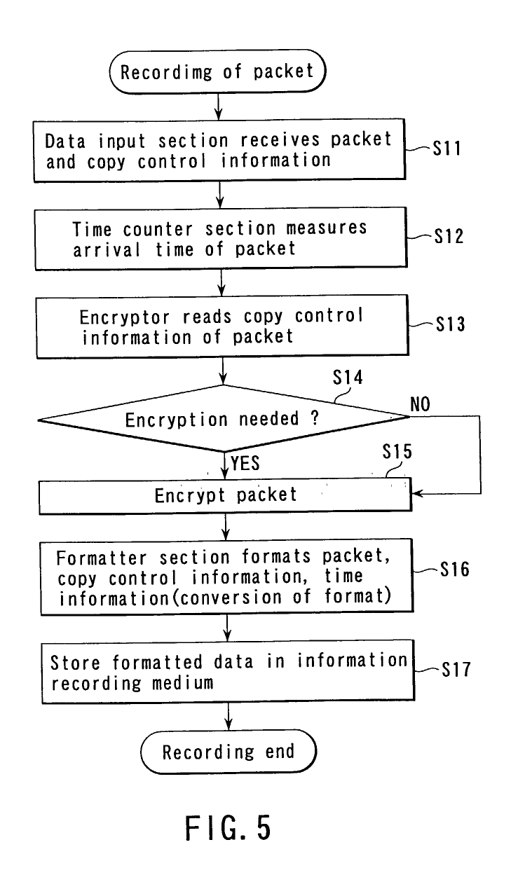

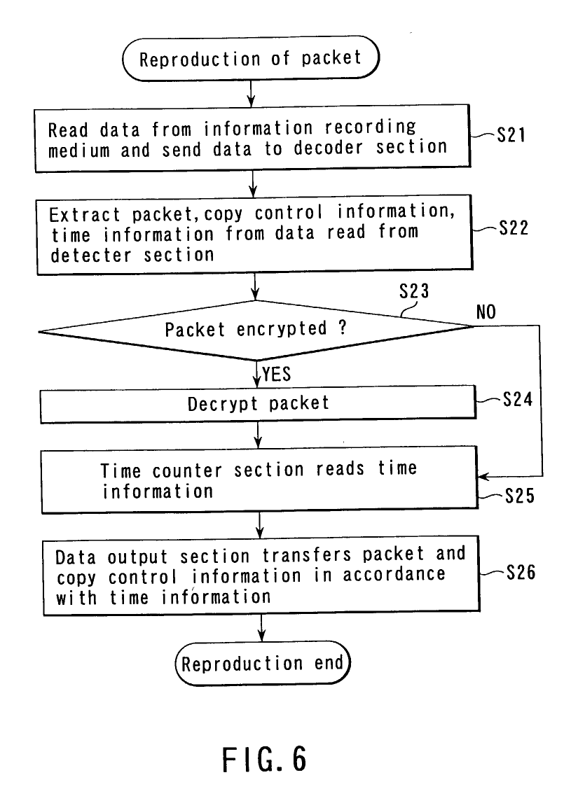

FIG. 1 is a system diagram showing one example of a system for recording/reproduction the data packet according to the present invention, FIG. 2 is a diagram showing a data structure in recording packets in a DVD-SR standard, FIG. 3 is an explanatory view showing one example of a recording function of the information recording/reproduction apparatus according to the present invention, FIG. 4 is an explanatory view showing one example of a reproduction function, FIG. 5 is a flowchart showing one example of the recording function, and FIG. 6 is a flowchart showing one example of the reproduction function.

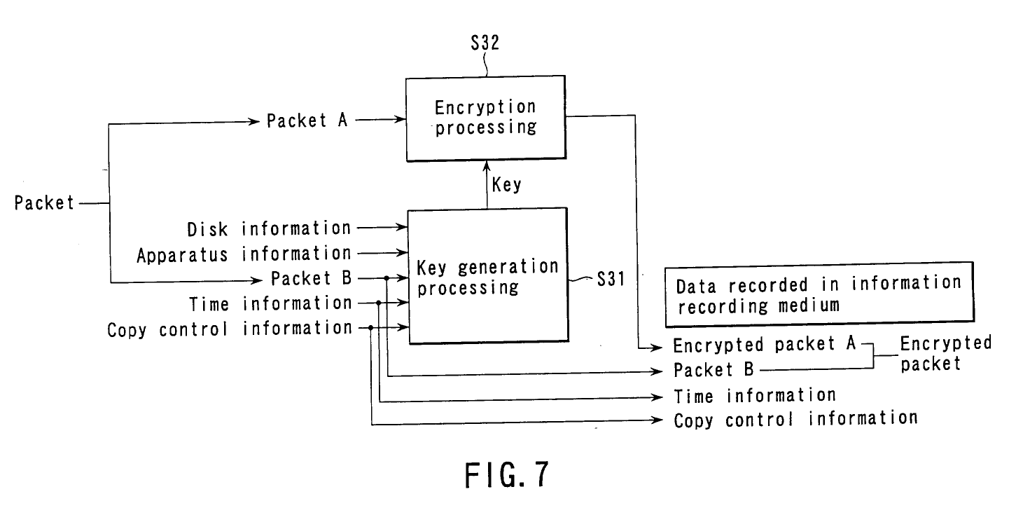

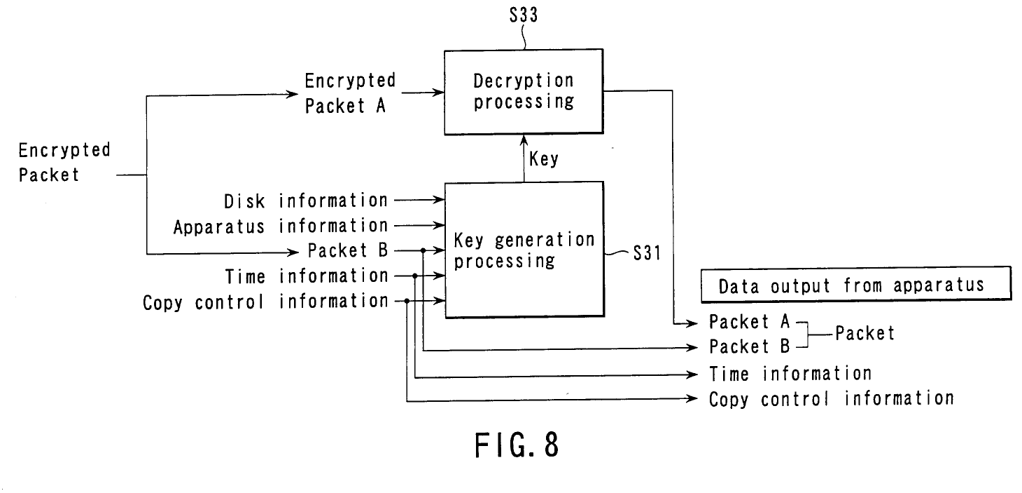

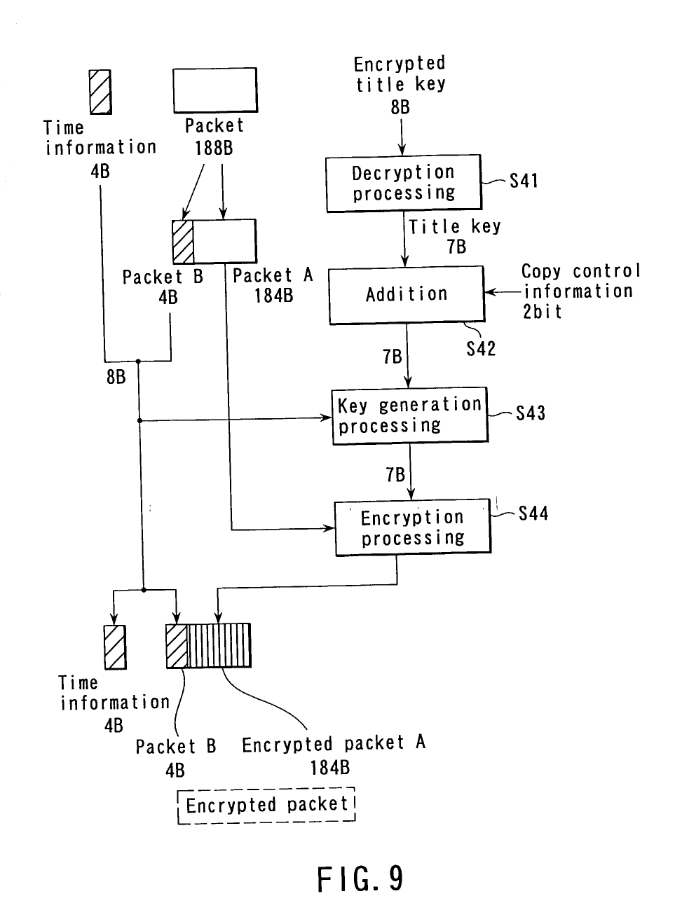

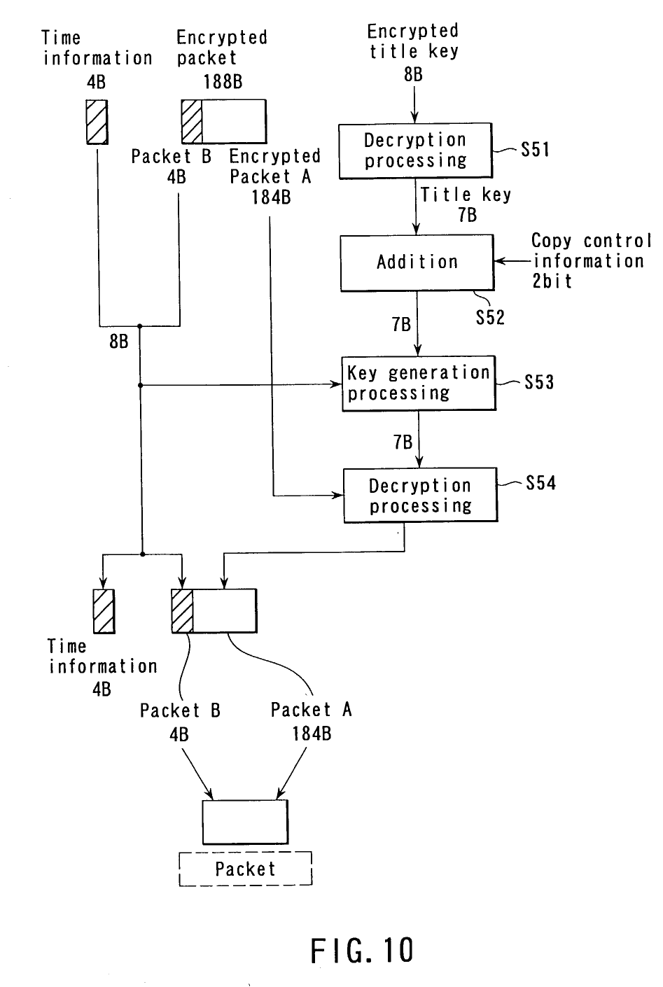

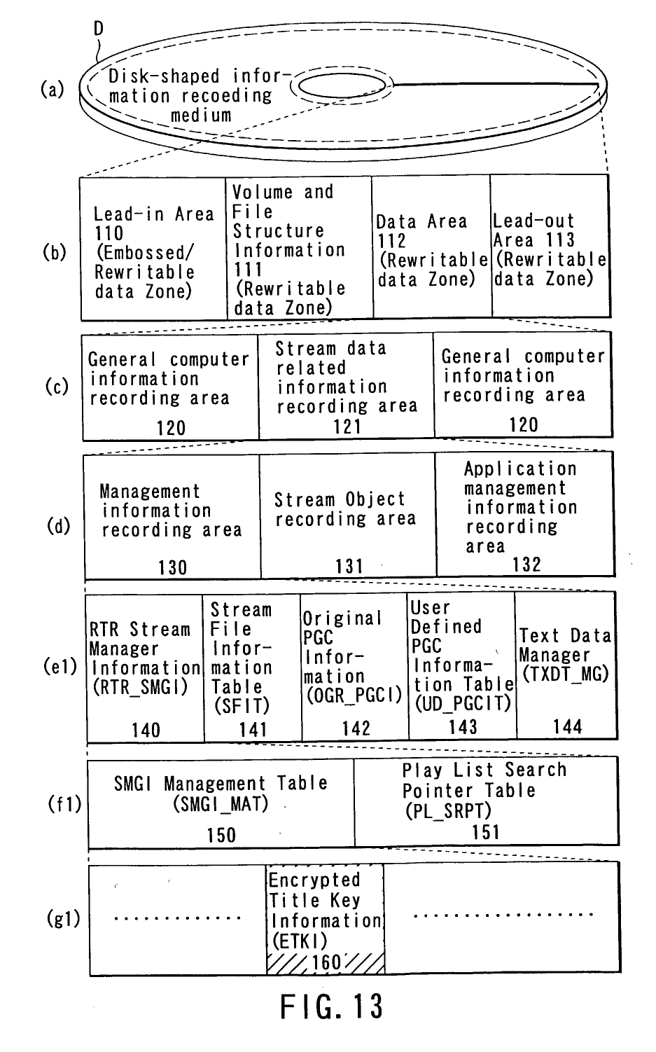

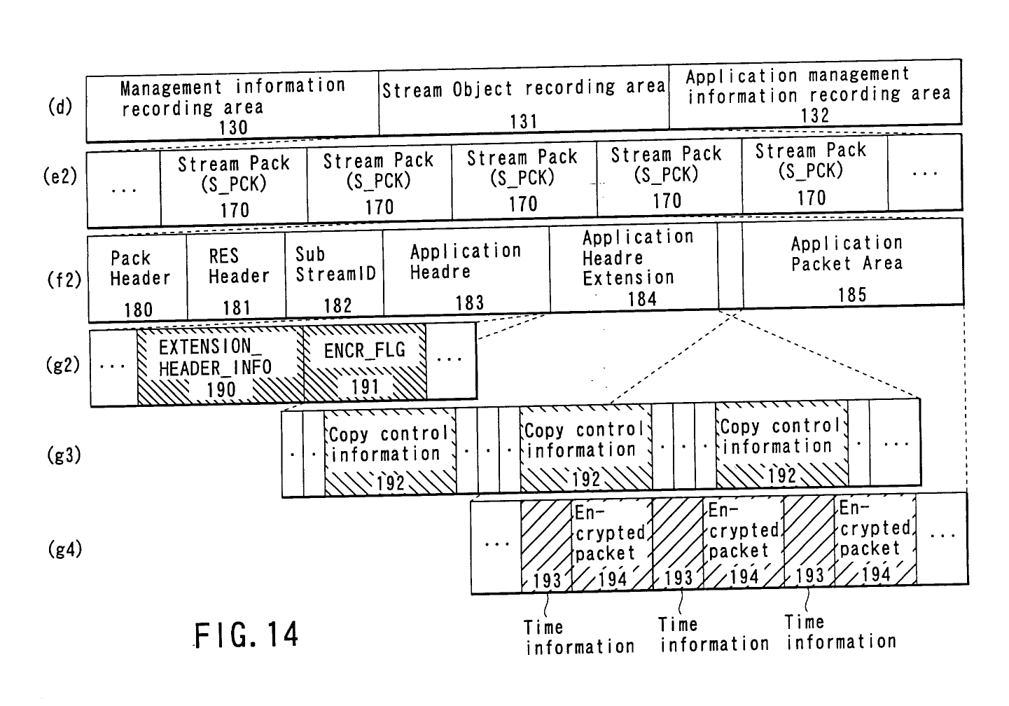

Moreover, FIG. 7 is an explanatory view showing one example of the recording function, FIG. 8 is an explanatory view showing one example of the reproduction function, FIG. 9 is an explanatory view showing an encryption process of the information recording/reproduction apparatus, FIG. 10 is an explanatory view showing a decryption process of the information recording/reproduction apparatus, FIG. 13 is a diagram showing one example of a structure of management information of an information recording medium, and FIG. 14 is a diagram showing one example of a structure of object information of the information recording medium.

An information recording/reproduction apparatus A according to the present invention represents an information processing system for recording/reproduction the data packet in FIG. 1. The data packet (e.g., 188 bytes for MPEG transport stream (MPEG-TS)) distributed via satellite digital broadcasting is received by a set top box S via a receiver R.

The STB S includes, for example, a tuner section 1 and MPEG processor section 2. The received data packet is sent to the information recording/reproduction apparatus A via digital interfaces such as an IEEE 1394 interface. The information recording/reproduction apparatus A allocates time information to each packet of the sent data packet, and records the data packet in an information recording medium D together with time information.

Moreover, for the reproduction, the information recording/reproduction apparatus A reads the time information and packet from the information recording medium D, and sends the packet to the STB S via the digital interface in accordance with the time information. The STB S subjects the packet to an MPEG decode, that is, converts the packet to an analog signal for analog television, but transfers the packet as such to a digital television T.

To record the above-described packet in information recording media such as DVD-RAM, DVD-RW, and DVD-R, a DVD stream recording (DVD-SR) standard argued in DVD forum is applied.

FIG. 2 shows a data structure in recording the packet in the DVD-SR standard. In the DVD-SR standard, the received packet (of 188 bytes for MPEG-TS) and time information (4 bytes) are alternately recorded to constitute the pack (2048 bytes) in conformity with MPEG program stream.

For 2048 bytes of MPEG-PS packs, 32 packs, that is, 64 kB is a unit of edition (SOBU). A SOB representing one program is constituted of one or more SOBU, and object data of DVD-SR is constituted of one or more SOBs. Management information including the object data, and information indicating a reproduction order of the object data are recorded in the information recording medium D.

Recording Processing

FIG. 3 shows an example of an apparatus proposed in the present invention, which encrypts the data packet and records the data in the information recording medium D. A recording apparatus A1 includes: a data input section 65 for receiving packets and copy control information through a digital interface; a time counter section 13 for measuring the time the packet has arrived; an encryptor 11 for using information such as copy control information, time information, apparatus information, and information (disk information) of the information recording medium D to encrypt the packet; a formatter section 12 for converting the encrypted packets, copy control information, and time information to a format of the information recording medium D; and the information recording medium D for recording the converted data.

FIG. 5 is a flowchart showing a rough flow in which the packet is received via the digital interface, encrypted, and recorded in the information recording medium D. In the flowchart, the information recording/reproduction apparatus A receives the packet to be recorded and copy control information via the data input section 65 of the digital interface (S11). Moreover, the time counter section 13 of the recording apparatus A1 measures the time each packet reaches the apparatus A1, and generates time information for each packet (S12).

The copy control information includes, for example, “copy is prohibited”, “one copy is possible (encryption is necessary)”, “copy is possible (encryption is necessary)”, “copy is possible (encryption is unnecessary)”, and the recording apparatus A1 operates accordingly (S13). For example, the recording apparatus A1 does not perform a recording operation when “copy is prohibited”, but encrypts the packet (S15) when “one copy is possible (encryption is necessary)” (S14).

Furthermore, the apparatus changes the copy control information to “copy is prohibited”, performs only the encryption of the packet when “copy is possible (encryption is necessary)” (S15), and does not perform the encryption of the packet when “copy is possible (encryption is unnecessary)”. For the encryption, the encryptor 11 uses a part of the packet, copy control information, information concerning the time when the packet has arrived (time information), information of the recording apparatus A1, and information (disk information) of the information recording medium D to encrypt each packet.

Additionally, the formatter section 12 converts the encrypted packet, copy control information, and time information to a recording format of the information recording medium D (S16). Finally, the recording section records the recording data in the information recording medium D (S17).

Reproduction Processing

FIG. 4 shows an example of a reproduction apparatus A2 proposed in the present invention, which decrypts the data packet read from the information recording medium D. The reproduction apparatus A2 includes: a reproduction section for reading the data recorded in the information recording medium D; a decoder section 22 for extracting the packet, copy control information and time information from the read data; a decryption unit 21 for using a part of the packet, the copy control information, time information, apparatus information, and information (disk information) of the information recording medium D to decrypt the encrypted packet; the time counter section 13 for transferring the decrypted packet in accordance with the time information; and a data output section 65 for transferring the packet and copy control information through the digital interface.

FIG. 6 is a flowchart showing a rough flow in which the packet is read from the information recording medium D, decrypted, and transferred to the digital interface. In the flowchart of FIG. 6, the reproduction apparatus A2 reads reproduction data recorded in the information recording medium D by the reproduction section (S21).

The decoder section 22 extracts the packet, copy control information, and time information from the read data (S22). The copy control information includes, for example, “copy is prohibited”, “copy is possible (encryption is necessary)”, “copy is possible (encryption is unnecessary)”. In accordance with the information, the reproduction apparatus A2 performs decryption (S24) in the decryption unit 21 when “copy is prohibited” or “copy is possible (encryption is necessary)” (S23), and transfers the data as such, when “copy is possible (encryption is unnecessary)” (S25).

Furthermore, the time information is sent to the time counter section 13 (S26), and the packet read from the decryption unit 21 is output to the outside through the digital interface via the data output section 65 in accordance with the time information of the time counter section 13.

Encryptor

FIG. 7 shows an outline of the encryptor 11 for use in the present invention. A key necessary for the encryption is generated using the disk information recorded in the information recording medium D, apparatus image recorded in the recording apparatus, copy control information, a part of the packet, and time information.

As a part of the packet or the time information is used in a part of the key, it is therefore possible to encrypt the information with a different key for each packet, and it becomes difficult to decrypt this cipher. Moreover, only the packet excluding the part used in generating the key is encrypted, and the time information is not encrypted. Thereby, it is possible to quickly access the time information.

Decryption Unit

FIG. 8 shows an outline of the decryption unit 21 for use in the present invention. As shown in FIG. 7, for the generation of the key, the disk information recorded in the information recording medium D, apparatus image recorded in the reproduction apparatus, copy control information, a part of the packet, and time information are used.

That is, the same key as the key generated in the encryption is generated for the decryption. This key is used to decrypt the encrypted part of the packet. The decrypted packet part is put together with the packet part used as the key, and can be returned to the original packet.

Encryption Process

FIG. 9 is an explanatory view showing one example of a flow for encrypting the packet. A title key is a key of 7 bytes generated from the disk information recorded in the information recording medium D, and apparatus information recorded in the information recording/reproduction apparatus. The title key is encrypted, and recorded as the encrypted title key of 8 bytes in the information recording medium D. This title key is a key peculiar to the information recording medium, and is a common key as long as the information recording medium D is used. This encrypted tangent line is decrypted/processed, and the title key is obtained (S41).

Furthermore, the copy control information of 2 bits is added to the title key (S42), and a new key of 7 bytes is generated. The copy control information is included in the generated key. Therefore, even when the copy control information is falsified, this has no meaning. For example, even when the copy control information of the packet having an attribute “copy is prohibited” is changed to the copy control information indicating “copy is possible (encryption is necessary)”, the key for the decryption is different from the key for the encryption, and therefore the information cannot be decrypted.

Subsequently, a new key of 7 bytes is further generated from data of 8 bytes in total including the time information of 4 bytes and 4 bytes as a part of the packet (packet B in FIG. 9) and the above-described key of 7 bytes (S43). Since the time information differs with each packet, the generated key is peculiar to the packet. This key is used to encrypt the remaining part of the packet (packet A in FIG. 9) (S44).

For example, to encrypt an MPEG-TS packet of 188 bytes, a part of 4 bytes for use in the key is formed as a header part of the MPEG-TS. Then, the remaining 184 bytes are encrypted, and the header part of 4 bytes is not encrypted. Therefore, even when the MPEG-TS packet is encrypted, the attribute of the packet can be read from the header part.

Finally, the packet part (packet B) of 4 bytes used in generating the key is put together with the remaining encrypted packet part (encrypted packet A in FIG. 9) (this combined packet will be referred to as the encrypted packet. This combined packet is recorded in the information recording medium D together with the time information and copy control information.

Decryption Process

FIG. 10 is an explanatory view showing one example of a flow for decrypting the packet encrypted as shown in FIG. 9. First, the encrypted title key of 8 bytes is read from the information recording medium D, and subjected to a decryption processing to generate the title key of 7 bytes (S51). Subsequently, the copy control information of 2 bits read from the information recording medium D is added to the title key (S52), and a new key of 7 bytes is generated.

Moreover, a new key of 7 bytes is generated from data of 8 bytes in total formed by combining the time information of 4 bytes read from the information recording medium D and 4 bytes as a part of the packet (packet B in FIG. 10), and the above-described key of 7 bytes (S53). This series of processes is the same as the process for generating the key for the encryption of the packet. That is, the key for the decryption is the same as the key used in the encryption.

For example, with the MPEG-TS recorded as shown in FIG. 9, the time information of 4 bytes, a part of non-encrypted packet of 4 bytes (packet B), and a part of the encrypted packet of 184 bytes (encrypted packet A) are recorded in the information recording medium D. The encrypted packet of 184 bytes is decrypted using the above-described key of 7 bytes. A part of the decrypted packet of 184 bytes (packet A) is combined with one part of the packet of 4 bytes (packet B), and decrypted to obtain the original MPEG-TS packet of 188 bytes (S54)

Management Information

In FIG. 13, a data area 112 as an area in which a user can record the information in the information recording medium D in the form of a rewritable disk as the information recording medium according to the present invention is formatted, so that general computer information recording area 120 and stream data related information recording area 121 can exist in a mixed manner.

In the embodiment of the present invention, recordable data packet will be referred to as an object. The object is recorded in a stream object recording area 131, and information concerning the object is recorded in a management information recording area 130. Moreover, information of STB connected to the information recording/reproduction apparatus in the present invention is recorded in an application management information recording area 132.

The management information recording area 130 includes: RTR stream manager information (RTR_SMGI) 140 in which management information of the recorded object is recorded; a stream file information table (SFIT) 141 in which attribute information of the recorded object is recorded; original PGC information (ORG_PGC) 142 in which the reproduction information is recorded; a user defined PGC information table (UD_PGCIT) 143 in which play list information is recorded; and a text data manager (TXDT_MG) 144 in which text information is recorded.

Moreover, the RTR stream manager information (RTR_SMGI) 140 includes an SMGI management table (SMGT_MAT) 150 in which the management information of the object is recorded, and a play list search pointer table (PL_SRPT) 151 in which play list information is recorded. The encrypted tangent line in the embodiment of the present invention is recorded in the encrypted title key information (ETKI) 160 in the SMGI management table (SMGI_MAT) 150.

Object Information

FIG. 14 shows a structure example of the object information of the information recording medium D. In the embodiment of the present invention, as described above, the data packet is recorded as the stream object in the stream object recording area 131. Stream packs (S-PCK) 170 of 2048 bytes conforming to MPEG program stream are recorded in the stream object recording area 131. Each stream pack (S_PCK) 170 includes a pack header 180, PES header 181, sub stream ID 182, application header 183, application header extension 184, and application packet area 185.

The application header 183 includes EXTENSION_HEADER_INFO 190, ENCR_FLG 191, and the like. The EXTENSION_HEADER_INFO 190 is information indicating whether or not the area of the application header extension 184 is secured. When the copy control information is recorded, “10b” or “11b” meaning the securing of the area of the application header extension 184 is set.

The ENCR_FLG 191 is information indicating whether or not the stream pack (S_PCK) 170 includes the encrypted packet. To include one or more pieces of the copy control information meaning the encryption of the packet, “1b” which means the encrypted packet is included in the stream pack (S_PCK) 170 is set.

The application header extension 184 includes the same number of pieces of copy control information 192 as the number of packets included in the stream pack (S_PCK) 170. The copy control information 192 has a one-to-one correspondence with the packet in the stream pack (S_PCK) 170. For example, “00” is a value indicating “copy is possible (encryption is unnecessary)”, “11b” is a value indicating “copy is prohibited”, and “10b” is a value indicating “copy is possible (encryption is necessary)”. These and other values are set into the copy control information 192.

The application packet area 185 includes time information 193 indicating a time when the packet has arrived and encrypted packet 194. The time information 193 has a one-to-one correspondence with the encrypted packet 194. The time information and packet are alternately recorded like the time information 193, encrypted packet 194, time information 193, encrypted packet 194, . . .

As described above, according to the first embodiment of the present invention, the key information which differs with each packet, such as the arrival time and header of the packet, are used, and this makes it very difficult to decipher predetermined information having a plurality of packets. Furthermore, the time information is stored in the information recording medium D unencrypted. Therefore, when the time information is used to access the information, a quick processing is possible.

<Second Embodiment>

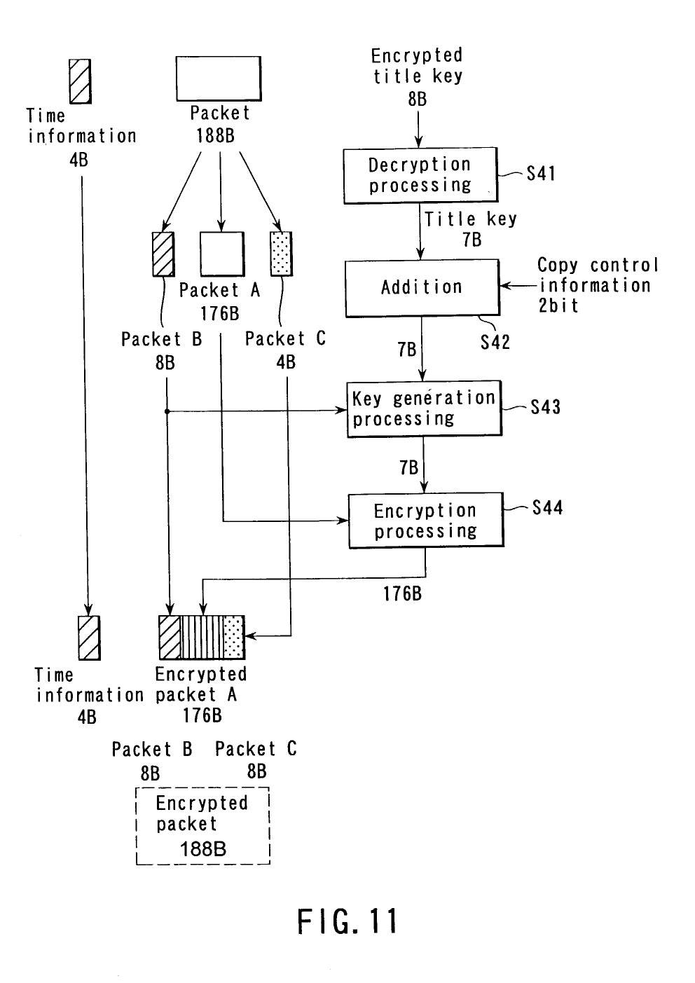

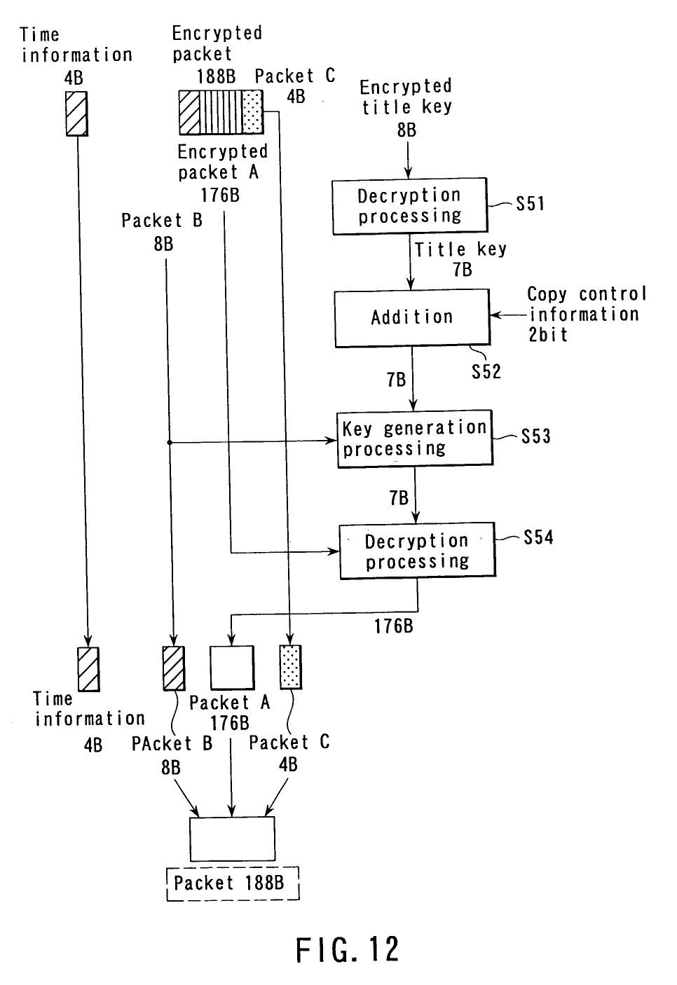

According to a second embodiment, there are provided the information recording/reproduction apparatus, information recording medium and information recording/reproduction method in which the key information different with each data packet is used to encrypt the data packet. Particularly, for the key information, the header (or one part thereof) included in the data packet is used. FIG. 11 is an explanatory view showing the encryption process of the information recording/reproduction apparatus according to the second embodiment of the present invention, and FIG. 12 is an explanatory view showing the decryption process of the information recording/reproduction apparatus according to the second embodiment of the present invention.

Encryption Process

FIG. 11 is an explanatory view showing the encryption process of the information recording/reproduction apparatus according to the second embodiment of the present invention. Different from FIG. 9, without using the time information, only one part of the packet is used to generate the key. Moreover, for a reason of restriction of an encryption technique, there exists an encrypted packet part.

First, the information recording/reproduction apparatus reads out the encrypted title key recorded in the RTR stream manager information (RTR_SMGI) of the information recording medium D, and decrypts the key to obtain the title key (S41). Furthermore, the copy control information of 2 bits is added to the title key (S42), and a new key of 7 bytes is generated (S43). This processing is the same as the generation processing of the key of FIG. 9.

For example, to encrypt the MPEG-TS packet of 188 bytes, 8 bytes of the packet (packet B in FIG. 11, this is a header as one example) are used as one part of the key, and a new key of 7 bytes is generated from the above-described key of 7 bytes. This key is used to encrypt 176 bytes (packet A in FIG. 11) of the remaining packet part (encrypted packet A) (S44). Furthermore, the remaining packet part of 4 bytes (packet C in FIG. 11) is a packet part which is not encrypted and does not form one part of the key.

Finally, the time information, packet part (packet B) as one part of the key, encrypted packet part (encrypted packet A) and other packet part (packet C) are recorded as the encrypted packet in the information recording medium D.

Decryption Process

FIG. 12 is an explanatory view showing the decryption process of the information recording/reproduction apparatus according to the second embodiment of the present invention, and shows one example of the flow for decrypting the encrypted packet similarly as FIG. 11. First, the encrypted title key of 8 bytes is read from the information recording medium D, and subjected to the decryption processing to generate the title key of 7 bytes (S51). Subsequently, the copy control information of 2 bits read from the information recording medium D is added to the title key (S52). Furthermore, the packet part of 8 bytes (packet B) which has been one part of the key in the encryption is used to generate a new key of 7 bytes (S53). The key for the decryption is the same as the key generated in the encryption.

For example, with the MPEG-TS recorded as shown in FIG. 11, the time information of 4 bytes, the packet part (packet B) forming one part of the key of 8 bytes, the encrypted packet part of 176 bytes (encrypted packet A), and the part of 4 bytes which is not encrypted and does not form one part of the key (packet C) are recorded in the information recording medium D.

The encrypted packet part (encrypt packet A) of 176 bytes is decrypted using the above-described key of 7 bytes. The decrypted packet part of 176 bytes (packet A) is combined with the packet part forming one part of the key (packet B) and the other packet part (packet C) to restore the original MPEG-TS packet of 188 bytes.

As described above, according to the second embodiment of the present invention, the key information for performing the encryption/decryption of the data packet is generated, for example, using the packet B as the header information without referring to the time information, different from the first embodiment. This makes it difficult for a third party to decipher the information. Furthermore, the time information is stored in the information recording medium unencrypted. Therefore, when the time information is used to access the information, a quick processing is possible.

<Third Embodiment>

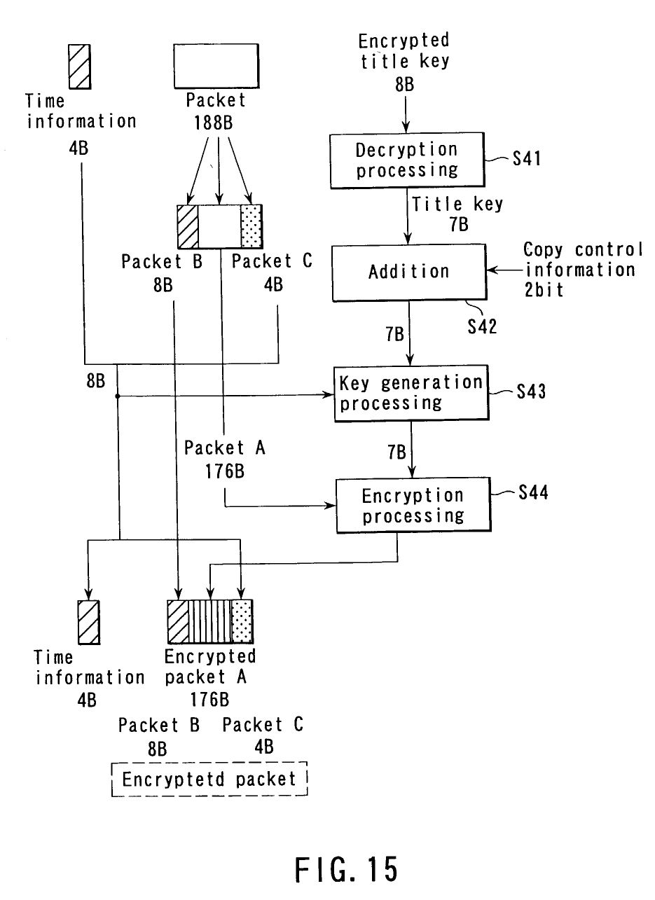

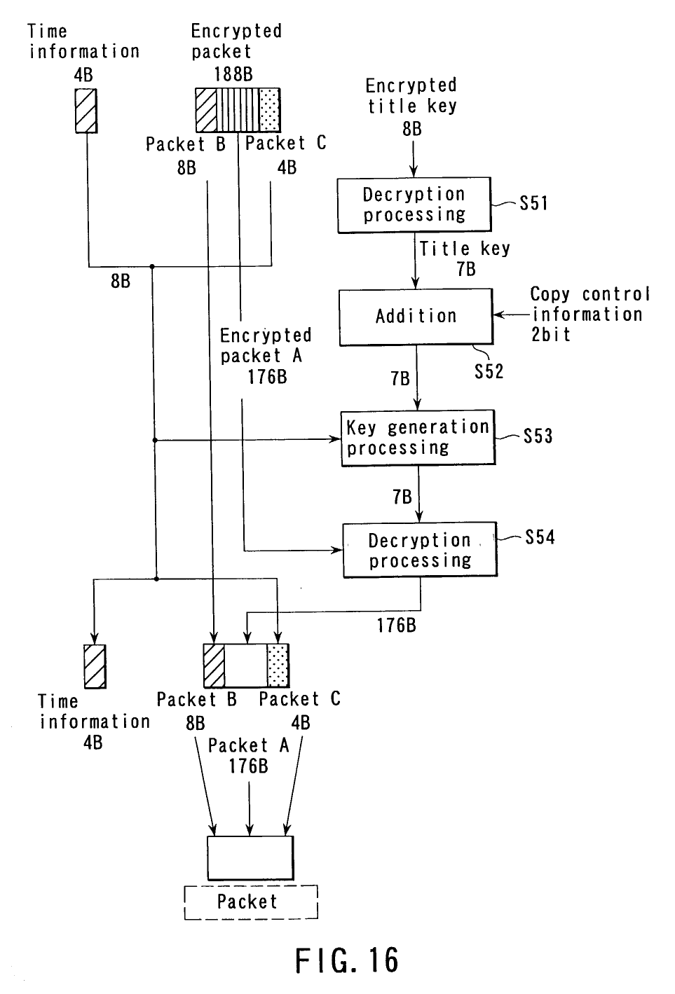

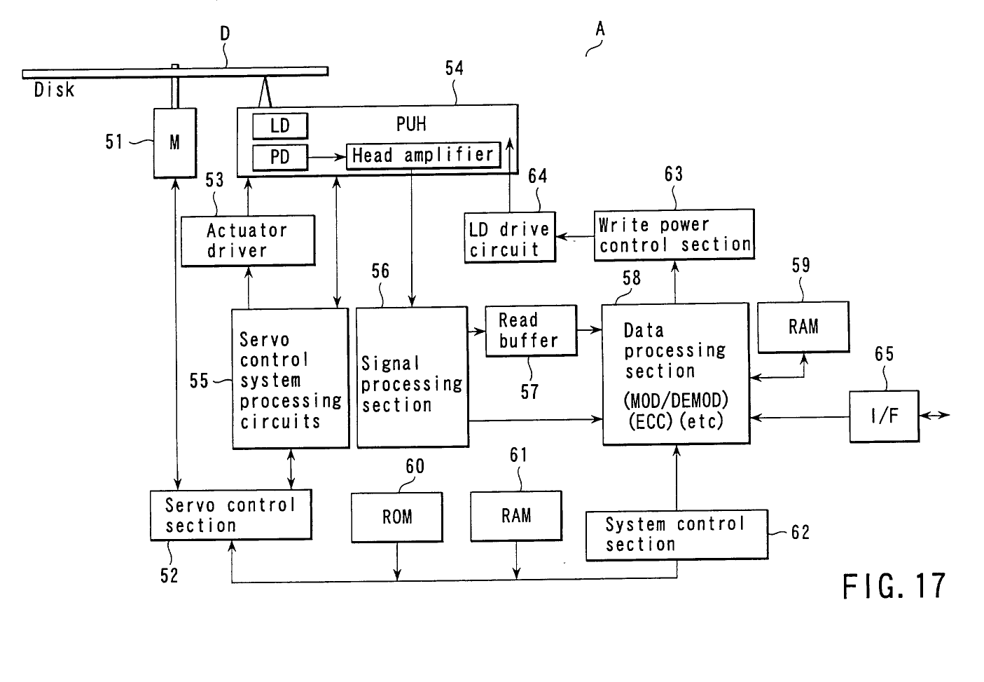

According to a third embodiment, there are provided the information recording/reproduction apparatus, information recording medium and information recording/reproduction method in which the key information different with each data packet is used to encrypt the data packet. Particularly, a case will be described in detail in which the key information is generated based on the time information indicating the arrival time and (one part of) a payload of the data packet. FIG. 15 is an explanatory view showing the encryption process of the information recording/reproduction apparatus according to the third embodiment of the present invention, FIG. 16 is an explanatory view showing the decryption process, and FIG. 17 is a block diagram showing one example of an optical disk information recording/reproduction apparatus according to the present invention.

Decryption Process

FIG. 15 shows the process of the encryption of the information recording/reproduction apparatus according to the third embodiment. Different from FIG. 9, there are three packets: an encrypted packet; a packet forming one part of the key; and a non-encrypted packet.

First, the information recording/reproduction apparatus reads out the encrypted title key recorded in the RTR stream manager information (RTR_SMGI) of the information recording medium D, and decrypts the key to obtain the title key (S41). Furthermore, the copy control information of 2 bits is added to the title key, and a new key of 7 bytes is generated (S42). Additionally, this processing is the same as the generation processing of the key of FIG. 9.

For example, to encrypt the MPEG-TS packet of 188 bytes, the time information of 4 bytes and 4 bytes of the packet (this corresponds to 4 bytes other than the header part, packet C in FIG. 15) are used as one part of the key, and a new key of 7 bytes is generated from the above-described key of 7 bytes S43). In the remaining packet part, 8 bytes including the MPEG-TS header of 4 bytes form the non-encrypted part (packet B in FIG. 15), and the remaining 176 bytes (packet A in FIG. 15) are encrypted using the above-described key (S44).

Since the MPEG-TS header includes the attribute information of the packet, it is preferable not to encrypt the header also for facilitating an access to the packet. Moreover, with an encryption unit of 8 bytes, 4 bytes of a part which cannot be encrypted is generated in this example. As a result, the non-encrypted part of 8 bytes exists.

Finally, the time information, packet part (packet C) as one part of the key, encrypted packet part (encrypted packet A) and other packet part including the header part (packet B) are recorded as the encrypted packet in the information recording medium D.

Decryption Process

FIG. 16 is an explanatory view showing the decryption process. In the drawing, first the encrypted title key of 8 bytes is read from the information recording medium D, and subjected to the decryption processing to generate the title key of 7 bytes (S51). Subsequently, the copy control information of 2 bits read from the information recording medium D is added to the title key (S52). Furthermore, the packet time information of 4 bytes and the packet part (packet C) of 4 bytes which has been one part of the key in the encryption are used to generate a new key of 7 bytes (S53). The key for the decryption is the same as the key generated in the encryption.

For example, with the MPEG-TS recorded as shown in FIG. 15, the time information of 4 bytes, the packet part (packet C) of 4 bytes forming one part of the key, the encrypted packet part of 176 bytes (encrypted packet A), and the part of 8 bytes which includes the header part, is not encrypted and does not form one part of the key (packet C) are recorded in the information recording medium D.

The encrypted packet part (encrypt packet A) of 176 bytes is decrypted using the above-described key of 7 bytes (S54). The decrypted packet part of 176 bytes (packet A) is combined with the packet part forming one part of the key (packet C) and the other packet part (packet B), so that the original MPEG-TS packet of 188 bytes can be restored.

As described above, according to the third embodiment of the present invention, the key information for performing the encryption/decryption of the data packet is generated using the time information indicating the arrival time of the packet and one part of the payload part (information of the packet other than the header). This makes it difficult for a third party to decipher the information. Furthermore, the time information is stored in the information recording medium D unencrypted. Therefore, when the time information is used to access the information, a quick processing is possible.

Embodiment of Optical Disk Recording/Reproduction Apparatus of the Invention

As a concrete example for performing the processing of the above-described information recording/reproduction apparatus, an optical disk recording/reproduction apparatus will next be described in detail. FIG. 17 is a block diagram showing one example of the optical disk recording/reproduction apparatus which performs an encryption/decryption processing according to the present invention.

In FIG. 17, a system control section 62 uses a RAM 61 as an operation area, and performs a predetermined operation according to program which is recorded in a ROM 60 and includes the present invention. An optical disk D is irradiated with a light output from an optical pickup 54. The reflected light from the optical disk D is converted to an electric signal by a head amplifier. This electric signal is inputted into a signal processing section 56. The signal processing section 56 has an RF amplifier.

Moreover, a servo control system processing circuits 55 includes an objective lens induction circuit, focus control circuit, objective lens drive signal switch, objective lens drive circuit, a wobble (WB) signal detection section, and the like, removes plane vibration of the optical disk, and performs a steady focus drawing operation.

With the operation, a wobble signal is also detected, and a generated write clock is supplied to a read buffer 57.

During a data write operation, a data processing section 58 uses the write clock generated by a write channel circuit (not shown) to add an error detection code (EDC) and ID to data sent via the interface 65. The data is subjected to a data scramble processing in order to stabilize servo. Furthermore, an error correction code (ECC) and synchronous signal are added. Moreover, signals other than the synchronous signal are modulated and sent to a write power control section 63. By a write strategy optimum for the corresponding medium, the signals are written into the optical disk D via a laser diode drive circuit 64.

In this case, the encryption process of the encryptor 11 according to the present invention described with reference to FIG. 3 is performed as a signal processing of the data processing section 58. The predetermined key information is generated for each data packet, the data is used to encrypt the above-described data packet, and the recording processing is performed.

During readout, an RF signal read from a head amplifier of the optical pickup 54 is sent to the read buffer 57 and PLL circuit through an optimum equalizer. The channel data is read by the read buffer 57 with the read clock generated in the PLL circuit. For the read data, the data processing section 58 reads synchronized symbol data. Thereafter, the data is subjected to error correction and descramble processing, and transferred to the outside via the interface 65.

Similarly, the decryption processing of the decryption unit 21 according to the present invention described with reference to FIG. 4 is performed as a signal processing of the data processing section 58. The predetermined key information is generated for each data packet, used to decrypt the above-described decryption of the data packet, and the reproduction processing is performed.

In this manner, the above-described optical disk recording/reproduction apparatus A performs the encryption/decryption processing according to the present invention.

As described above in detail, according to the present invention, the predetermined information stored in the information recording medium is encrypted/decrypted with the key information which differs with each packet. This can make it very difficult for a third party to illegally decipher the information. Furthermore, referring to the time information indicating the arrival time of the data packet, the key information is generated. The time information is recorded in the recording area without being encrypted. Thereby, the access to the time information is accelerated. Thus, an information recording/reproduction apparatus, information recording medium and information recording/reproduction method in which a processing speed can be enhanced is obtained.

What is claimed is:

1. An information recording apparatus comprising:
an input section configured to input predetermined information as a plurality of data packet supplied as a unit of data packet;
an encryption section configured to use a plurality of pieces of key information which differ with each data packet to encrypt the predetermined information inputted by said input section; and
a recording section configured to record the encrypted predetermined information encrypted by said encryption section into a recording area of an information recording medium.

2. An information recording apparatus according to claim 1, wherein said plurality of pieces of key information are based on information indicating a time when each data packet has reached said input section.

3. An information recording apparatus according to claim 1, wherein said plurality of pieces of key information are based on information indicating a time when each data packet has reached said input section, and at least a part of data of a header area included in each data packet.

4. An information recording apparatus according to claim 1, wherein said plurality of pieces of key information are based on at least some data of the data packet.

5. An information recording apparatus according to claim 1, wherein said plurality of pieces of key information are based on information indicating a time when each data packet has reached said input section, and at least a part of a payload part of each data packet.

6. An information recording apparatus according to claim 1, wherein said recording section records the encrypted predetermined information encrypted by said encryption section together with information of time indicating a time when each data packet has reached said input section into the recording area of said information recording medium.

7. An information reproduction apparatus comprising:
a readout section configured to read out predetermined information which is stored in a recording area of an information recording medium and encrypted by a unit of data packet; and
a reproduction section configured to use a plurality of pieces of key information which differ with the data packet unit to decrypt and reproduce said predetermined information read out by said readout section.

8. An information reproduction apparatus according to claim 7, wherein said plurality of pieces of key information are based on information of a time when each data packet has reached an encryption apparatus during encryption of each data packet.

9. An information reproduction apparatus according to claim 7, wherein said plurality of pieces of key information are based on information of a time when each data packet has reached an encryption apparatus during encryption of each data packet, and at least a part of data of a header area included in each data packet.

10. An information reproduction apparatus according to claim 7, wherein said plurality of pieces of key information are based on at least some data of the data packet.

11. An information reproduction apparatus according to claim 7, wherein said plurality of pieces of key information are based on information of a time when each data packet has reached an encryption apparatus during encryption of each data packet, and at least a part of a payload part of each data packet.

12. An information reproduction apparatus according to claim 7, wherein said readout section reads out said encrypted predetermined information, and the information of a time when each data packet has reached an encryption apparatus from the recording area of said information recording medium.

13. An information recording medium which stores predetermined information encrypted for each data packet and in which a plurality of encrypted data packet encrypted by a plurality of pieces of key information different with each packet are stored in a recording area.

14. An information recording medium according to claim 13, wherein said plurality of pieces of key information are based on information of a time when each data packet has reached an encryption apparatus during encryption of each data packet.

15. An information recording medium according to claim 13, wherein said plurality of pieces of key information are based on information of a time when each data packet has reached an encryption apparatus to subject each data packet to an encryption processing, and at least a part of data of a header area included in each data packet.

16. An information recording medium according to claim 13, wherein said plurality of pieces of key information are based on at least some data of the data packet.

17. An information recording medium according to claim 13, wherein said plurality of pieces of key information are based on information of a time when each data packet has reached an encryption apparatus to subject each data packet to an encryption processing, and at least a part of a payload part of each data packet.

18. An information recording medium according to claim 13, wherein said encrypted data packet is stored together with information of a time when each data packet has reached an encryption apparatus.
